(19) United States
(12) Patent Application Publication
(10) Pub. No.: US 2022/0048728 A1
(43) Pub. Date: Feb. 17, 2022

(54) INTERCAR COORDINATION IN MULTICAR HOISTWAYS

(71) Applicant: Otis Elevator Company, Farmington, CT (US)

(72) Inventor: Arthur Hsu, South Glastonbury, CT (US)

(21) Appl. No.: 17/370,185

(22) Filed: Jul. 8, 2021

Related U.S. Application Data
(60) Provisional application No. 63/064,592, filed on Aug. 12, 2020.

(51) Int. Cl. B66B 1/24; B66B 1/22

(52) U.S. Cl. CPC B66B 1/2466; B66B 1/22

(57) ABSTRACT

A system includes a centralized controller configured to coordinate movement of a plurality of elevator cars in a multicar hoistway. The system also includes a plurality of car controllers configured to communicate with the centralized controller through a plurality of centralized control flows, establish two or more car-to-car control flows between at least two of the car controllers, and exchange an elevator car status between at least two of the car controllers. Movement of at least two of the elevator cars in the multicar hoistway is controlled based on the elevator car status and one or more commands received through at least one of the centralized control flows.

### CROSS-REFERENCE TO RELATED APPLICATIONS

This application is a U.S. Non-Provisional application which claims the benefit of U.S. Provisional Application No. 63/064,592, filed Aug. 12, 2020, of which is incorporated by reference in its entirety herein.

### BACKGROUND

Exemplary embodiments pertain to the art of elevator systems and, more particularly, to intercar coordination in multicar hoistways.

Self-propelled elevator systems, also referred to as ropeless elevator systems, are useful in certain applications (e.g., high rise buildings) where the mass of the ropes for a roped system is prohibitive and/or there is a desire for multiple elevator cars to travel in a single lane. There exist self-propelled elevator systems in which a first lane is designated for upward traveling elevator cars and a second lane is designated for downward traveling elevator cars under normal operating conditions. A transfer station at each end of the hoistway is used to move cars horizontally between the first lane and second lane. Additional lanes can also be supported.

Elevator system configurations that include multiple elevator cars per lane require coordinated control as the elevator cars can impede the travel of other elevator cars in the same lane. One control system configuration uses a centralized controller, referred to as a lane supervisor, to provide point-to-point control flows to car controllers assigned to each elevator car. This can work well but may result in long communication paths where the centralized controller is installed in a machine room at an extreme end of the elevator system relative to the positions of the car controllers.

### BRIEF DESCRIPTION

Disclosed is a system that includes a centralized controller configured to coordinate movement of a plurality of elevator cars in a multicar hoistway. The system also includes a plurality of car controllers configured to communicate with the centralized controller through a plurality of centralized control flows, establish two or more car-to-car control flows between at least two of the car controllers, and exchange an elevator car status between at least two of the car controllers. Movement of at least two of the elevator cars in the multicar hoistway is controlled based on the elevator car status and one or more commands received through at least one of the centralized control flows.

In addition to one or more of the features described herein, or as an alternative, further embodiments may include where the one or more commands received through at least one of the centralized control flows are relayed on at least one of the car-to-car control flows.

In addition to one or more of the features described herein, or as an alternative, further embodiments may include where the car controllers are configured to use a relayed version of the one or more commands received on at least one of the car-to-car control flows based on detecting a fault in one of the centralized control flows directly received from the centralized controller.

In addition to one or more of the features described herein, or as an alternative, further embodiments may include where the car controllers are configured to compare a relayed version of the one or more commands received on at least one of the car-to-car control flows to the one or more commands received directly received from the centralized controller.

In addition to one or more of the features described herein, or as an alternative, further embodiments may include where the elevator car status includes one or more of a safety chain status, a target stopping floor, and a motion status.

In addition to one or more of the features described herein, or as an alternative, further embodiments may include where control of at least two of the elevator cars in the multicar hoistway includes delaying one or more of elevator door closure and elevator car departure based on the elevator car status or planning data received through at least one of the car-to-car control flows.

In addition to one or more of the features described herein, or as an alternative, further embodiments may include where control of at least two of the elevator cars in the multicar hoistway includes delaying completion of a movement command from the centralized controller in response to a movement delay status of a nearest elevator car in a targeted path of movement.

In addition to one or more of the features described herein, or as an alternative, further embodiments may include where control of at least two of the elevator cars in the multicar hoistway includes adjusting a travel speed based on planning data or the elevator car status of one or more elevator cars in a targeted path of movement.

In addition to one or more of the features described herein, or as an alternative, further embodiments may include where the two or more car-to-car control flows between at least two of the car controllers include at least one car-to-car control flow that extends beyond a nearest car controller in a targeted path of movement.

In addition to one or more of the features described herein, or as an alternative, further embodiments may include where control of at least two of the elevator cars in the multicar hoistway includes adjusting a targeted stopping floor based on the elevator car status or planning data received through at least one of the car-to-car control flows.

Also disclosed is a method that includes establishing a plurality of centralized control flows between a centralized controller and a plurality of car controllers of a multicar hoistway. Two or more car-to-car control flows are established between at least two of the car controllers. An elevator car status is exchanged between the at least two of the car controllers. Movement of at least two elevator cars in the multicar hoistway is controlled based on the elevator car status and one or more commands received through at least one of the centralized control flows.

In addition to one or more of the features described herein, or as an alternative, further embodiments may include relaying the one or more commands received through at least one of the centralized control flows on at least one of the car-to-car control flows.

In addition to one or more of the features described herein, or as an alternative, further embodiments may include using, by the car controllers, a relayed version of the one or more commands received on at least one of the car-to-car control flows based on detecting a fault in one of the centralized control flows directly received from the centralized controller.

In addition to one or more of the features described herein, or as an alternative, further embodiments may include comparing, by the car controllers, a relayed version of the one or more commands received on at least one of the car-to-car control flows to the one or more commands received directly received from the centralized controller.

In addition to one or more of the features described herein, or as an alternative, further embodiments may include where controlling movement of at least two of the elevator cars in the multicar hoistway includes delaying one or more of elevator door closure and elevator car departure based on the elevator car status or planning data received through at least one of the car-to-car control flows.

In addition to one or more of the features described herein, or as an alternative, further embodiments may include where controlling movement of at least two of the elevator cars in the multicar hoistway includes delaying completion of a movement command from the centralized controller in response to a movement delay status of a nearest elevator car in a targeted path of movement.

In addition to one or more of the features described herein, or as an alternative, further embodiments may include where controlling movement of at least two of the elevator cars in the multicar hoistway includes adjusting a travel speed based on planning data or the elevator car status of one or more elevator cars in a targeted path of movement.

In addition to one or more of the features described herein, or as an alternative, further embodiments may include where controlling movement of at least two of the elevator cars in the multicar hoistway includes adjusting a targeted stopping floor based on the elevator car status or planning data received through at least one of the car-to-car control flows.

### BRIEF DESCRIPTION OF THE DRAWINGS

The following descriptions should not be considered limiting in any way. With reference to the accompanying drawings, like elements are numbered alike:

FIG. 1 is a multicar ropeless elevator system in accordance with an embodiment of the present disclosure;

FIG. 2 is a distributed control system according to an embodiment of the present disclosure;

FIG. 3 is a multiple-drive control system, according to an embodiment of the present disclosure;

FIG. 4 is a control designation change in a multiple-drive control system, according to an embodiment of the present disclosure; and

FIG. 5 is a flow diagram illustrating a process, according to an embodiment of the present disclosure.

### DETAILED DESCRIPTION

A detailed description of one or more embodiments of the disclosed apparatus and method are presented herein by way of exemplification and not limitation with reference to the Figures.

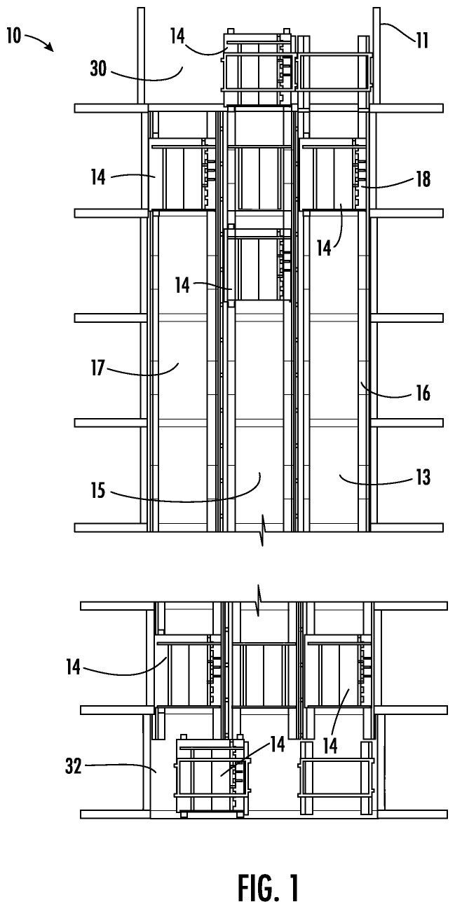

FIG. 1 depicts a multicar, self-propelled elevator system 10 in an exemplary embodiment. Elevator system 10 includes a hoistway 11 having a plurality of lanes 13, 15 and 17. While three lanes are shown in FIG. 1, it is understood that embodiments may be used with multicar elevator systems having any number of lanes and any desired means of propulsion. In each lane 13, 15, 17, cars 14 travel in one direction, i.e., up or down. For example, in FIG. 1 cars 14 in lanes 13 and 15 travel up and cars 14 in lane 17 travel down. One or more cars 14 may travel in a single lane 13, 15, and 17, and therefore, the hoistway 11 may also be referred to as multicar hoistway 11.

Above the top floor is an upper transfer station 30 to impart horizontal motion to elevator cars 14 to move elevator cars 14 between lanes 13, 15 and 17. It is understood that upper transfer station 30 may be located at the top floor, rather than above the top floor. Below the first floor is a lower transfer station 32 to impart horizontal motion to elevator cars 14 to move elevator cars 14 between lanes 13, 15 and 17. It is understood that lower transfer station 32 may be located at the first floor, rather than below the first floor. Although not shown in FIG. 1, one or more intermediate transfer stations may be used between the first floor and the top floor. Intermediate transfer stations are similar to the upper transfer station 30 and lower transfer station 32. Further, the upper transfer station 30 and/or lower transfer station 30 may be at any desired floor level.

Cars 14 can be propelled using a linear motor system having a primary, fixed portion 16 and a secondary, moving portion 18. The primary portion 16 can include windings or coils mounted at one or both sides of the lanes 13, 15 and 17. Secondary portion 18 can include permanent magnets mounted to one or both sides of cars 14. Primary portion 16 can be supplied with drive signals to control movement of cars 14 in their respective lanes. Other variations can include motors that are attached to the cars 14 rather than distributed between the cars 14 and lanes 13, 15, and 17. Although the example of FIG. 1 is described with respect to a linear motor system, it will be understood that embodiments can be implemented in any type of multiple car hoistway. For example, multicar elevator systems can use roped or ropeless systems to move the elevator cars 14 in lanes 13, 15, and 17. Embodiments may be employed in ropeless elevator systems using a hydraulic lift to impart motion to an elevator car. Embodiments may also be employed in ropeless elevator systems using self-propelled elevator cars (e.g., elevator cars equipped with friction wheels or traction wheels). FIG. 1 is merely a non-limiting example presented for illustrative and explanatory purposes.

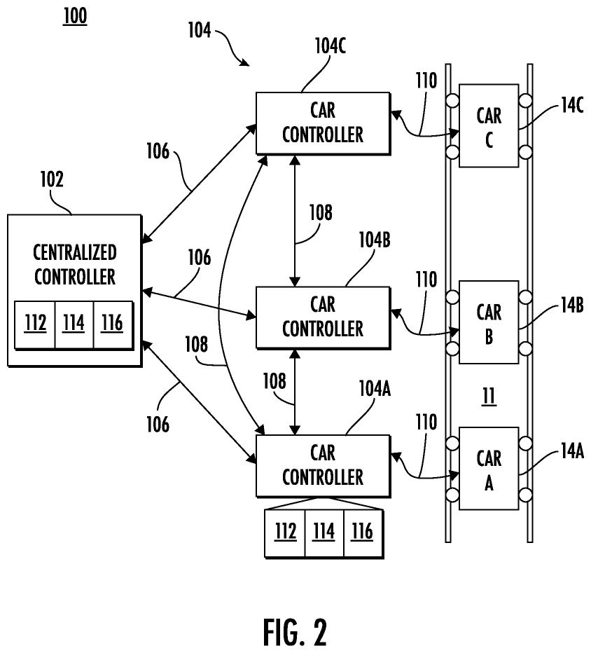

Turning now to FIG. 2, a distributed control system 100 for a multicar hoistway in accordance with one or more embodiments is shown. The distributed control system 100 can be used to control the elevator system 10 of FIG. 1. FIG. 2 depicts a portion of a control network 100 of elevator system 10 in accordance with an exemplary embodiment. A centralized controller 102 can act as a lane controller for an individual lane 13, 15, 17 of FIG. 1 or control movement of elevator cars 14 across two or more lanes 13, 15, 17 of hoistway 11. In the example of FIG. 2, there are three elevator cars 14 depicted in a same lane of travel in hoistway 11. Rather than relying upon direct point-to-point communications from the centralized controller 102 to corresponding car controllers 104a, 104b, and 104c to control elevator cars 14a, 14b, and 14c respectively, multiple communication paths are established to also communicate between car controllers 104. For instance, the centralized controller 102 can transmit and receive centralized control flows 106 with each car controller 104a, 104b, 104c. The car controllers 104 can communicate with each other through car-to-car control flows 108. Car controller 104a provides local control signals 110 to elevator car 14a, car controller 104b provides local control signals 110 to elevator car 14b, and car controller 104c provides local control signals 110 to elevator car 14c. In some embodiments, car-to-car control flows 108 may only occur between nearest neighboring car controllers 104. For example, the car-to-car control flow 108 between car controllers 104a and 104c may be omitted. In some embodiments, car-to-car control flow 108 may occur between all or any desired subgroup of cars 14. Providing more car-to-car control flows 108 can enhance redundancy in case of a communication fault but also adds to system complexity. In some embodiments, car-to-car control flows 108 may be grouped such that each car controller 104 communicates with a group of car controllers 104, such as the nearest two neighboring car controllers 104 in the same lane 13, 15, 17.

Each of the centralized controller 102, and car controllers 104 can include a processing system 112, a memory system 114, and a communication interface 116, as well as other subsystems (not depicted). The processing system 112 may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory system 114 may be a storage device such as, for example, a random access memory (RAM), read only memory (ROM), or other electronic, optical, magnetic or any other computer readable storage medium. The memory system 114 can include computer-executable instructions that, when executed by the processing system 112, cause the processing system 112 to perform operations as further described herein. The communication interface 116 can include wired, wireless, and/or optical communication links to establish communication between controllers 102, 104. Other communication channels can be supported beyond those depicted in FIG. 2, such as cloud-based operations and processing to directly support or partially offload processing burdens, maintenance operations, and wider-scale controls, such as building-level systems, evacuation systems, and the like.

In the example of FIG. 2, elevator cars 14a, 14b, and 14c are depicted as ropeless beam climber elevator cars which can use one or more wheels to climb up or down within the hoistway 11. The car controllers 104a, 104b, 104c may determine how to drive one or more motors to control one or more wheels of the elevator cars 14a, 14b, and 14c. The car controllers 104a, 104b, 104c may also determine when to apply one or more brakes and other driving and stopping components. The car controllers 104a, 104b, 104c may monitor aspects of the elevator cars 14a, 14b, and 14c using various sensors to detect the position, speed, acceleration, vibration, health status, and other such conditions at each of the elevator cars 14a, 14b, and 14c. Similarly, in other embodiments, the car controllers 104a, 104b, 104c can control motion of the elevator cars 14a, 14b, and 14c based on sensor data, commands from the centralized controller 102, and the status of the elevator cars 14a, 14b, and 14c as reported by the car controllers 104a, 104b, 104c through car-to-car control flows 108.

Providing car-to-car control flows 108 that extend beyond the nearest neighboring car controllers 104a, 104b, 104c can provide an extended reaction time. For example, car controller 104c may notify both car controllers 104a and 104b of a reduction in speed of elevator car 14c. Rather than waiting for the centralized controller 102 to detect the condition and relay the condition to car controllers 104a and 104b, the earlier notification through car-to-car control flows 108 between car controllers 104c and 104a and between car controllers 104c and 104b, can provide a greater response and reaction time to slow or stop movement of elevator cars 14a and 14b. Further, direct notification from car controller 104c to car controller 104a removes the lag time of car controller 104b determining a change in motion of elevator car 14b and then informing car controller 104a. For instance, if the car controller 104c determines that the speed of elevator car 14c is/should be reduced or the elevator car 14c is stopped, the condition can be reported to car controllers 104a and 104b. The car controller 104a may initially slow the speed of elevator car 14a while waiting for a response or status update from car controller 104b about elevator car 14b. When car controller 104b determines an accommodation, such as changing a targeting stopping floor or reducing the speed of the elevator car 14b, the car controller 104b can report the accommodation action and status of elevator car 14b to car controller 104a. Speed changes can be implemented as ramping functions or modulation between two or more speeds to adjust the average speed of elevator cars 14. Based on the updated status from car controller 104b, the car controller 104a may adjust/shorten a targeted stopping floor or speed of elevator car 14a. Further, the exchange of data on the car-to-car control flows 108 can delay starting times, such as when elevator cars 14b and/or 14c are stopped ahead of elevator car 14a. A delay may keep elevator doors open at a landing for an extended period of time to allow for elevator cars 14b and/or 14c to resume motion before elevator doors of elevator car 14a are closed. This approach can apply to any type of multicar elevator or motion system where conveyance components share a common travel path.

Data exchanged on the car-to-car control flows 108 may also include future state information. For example, the car controllers 104a, 104b, 104c can exchange targeted stopping floor, planned travel speed, planned delays, and other such planning information. The planning information can be used by other car controllers 104a, 104b, 104c to adjust a travel plan of a corresponding elevator car 14a, 14b, 14c. For instance, if the targeted stopping floor of elevator car 14c is shortened, this change in plans can be relayed to modify travel plans of elevator cars 14a and 14b. By receiving a change in travel plans through car-to-car control flows 108, the car controllers 104a and 104b may have more options in adjusting the travel plans of elevator cars 14a and 14b. For instance, car controller 104a may use a combination of extended elevator door open times and reduced speed to make up for the change in travel plans, while car controller 104b may use a different approach to accommodate for the change in travel plans of elevator car 14c.

Although depicted as a primarily vertical travel configuration, it will be understood that the control systems described herein can apply to horizontal or diagonal motion in transfer carriage systems as well.

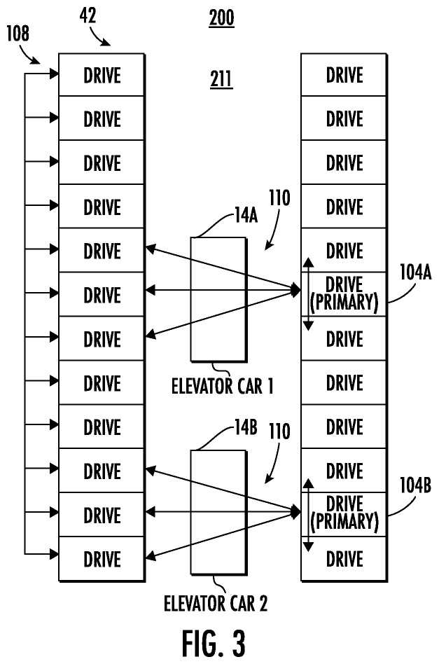

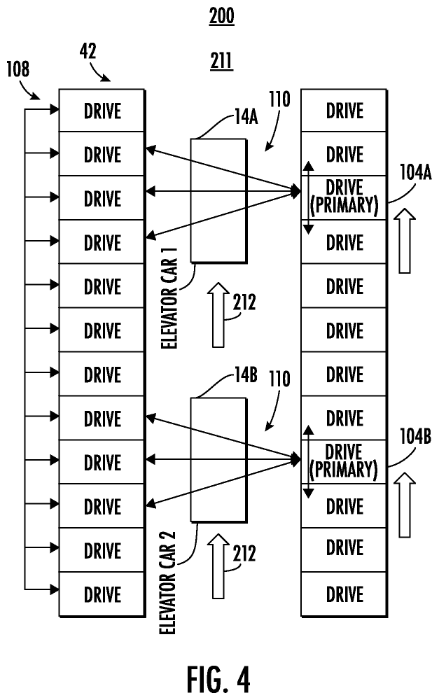

FIGS. 3 and 4 depict a multiple-drive control system 200 as an embodiment of the elevator system 10 of FIG. 1. In the example of FIGS. 3 and 4, drives 42 are distributed throughout hoistway 211. The drives 42 may be configurable as car controllers 104 with the designation of a drive as a car controller 104 changing as an elevator car 14 moves through the hoistway. A drive 42 designated as a primary drive becomes a car controller 104 for a closest elevator car 14 and can distribute local control signals 110 to neighboring drives 110 and/or to control components of the elevator car 14. Car-to-car control flows 108 can be established by a multi-drop or point-to-point network between the drives 42 to exchange elevator car status and pass control data associated with localized control of the elevator cars 14 with respect to each other.

As one example, one of the drives 42 in the hoistway 211 designated as a primary drive of elevator car 14A can act as the car controller 104A while the elevator car 14A is in close physical proximity. Another drive 42 in the hoistway 211 designated as a primary drive of elevator car 14B can act as the car controller 104B while the elevator car 14B is in close physical proximity. As the elevator cars 14A, 14B advance in a direction of travel 212, the designation of the primary drives of elevator cars 14A, 14B changes to advance along with the elevator cars 14A, 14B. Shorter-distance data exchanges can be communicated through local control signals 110 and car-to-car control flows 108. It will be understood that each side of the hoistway 211 can include communication channels to support car-to-car control flows 108 as well as the centralized control flows 106 of FIG. 2. Data communicated through local control signals 110 can include inner control loop parameters, such as motor currents, motor speed, torque, health status, and the like. Data communicated through car-to-car control flows 108 may include elevator car level information, such as elevator car 14 position, velocity, safety chain status, loading, and other such information. Data communicated through the centralized control flows 106 of FIG. 2 can include calls of elevator cars 14 to specific floors within a structure and other such dispatching data and commands.

Similar approaches can be used for other types of multicar elevator or motion systems where conveyance components share a common travel path. Further, the multiple-drive control system 200 can use other approaches as described in reference to FIGS. 1-2 and 5 to control relative speed, acceleration, targeting stopping floor, delayed starting, and other such performance characteristics of elevator cars 14.

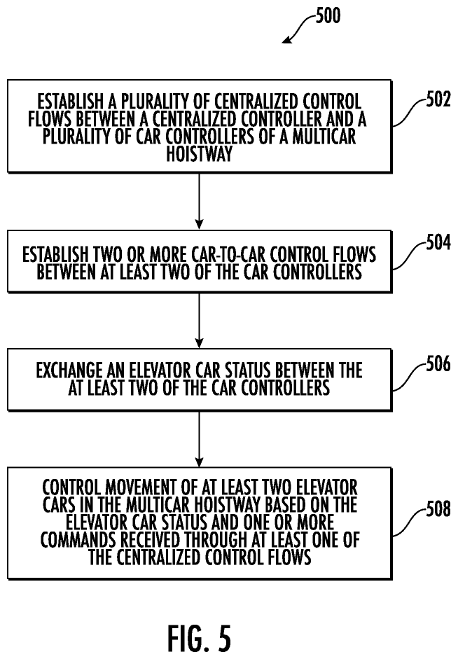

Referring now to FIG. 5 with continued reference to FIGS. 1-4, FIG. 5 depicts a flow chart of a method 500 in accordance with an embodiment of the disclosure. The method 500 can be performed, for example, by the systems 100 and 200 of FIGS. 2-4 or any other multicar elevator system configuration. For purposes of explanation, method 500 is described primarily with respect to systems 100 and 200.

At block 502, a plurality of centralized control flows 106 is established between a centralized controller 102 and a plurality of car controllers 104 of a multicar hoistway 11, 211.

At block 504, two or more car-to-car control flows 108 are established between at least two of the car controllers 104.

At block 506, an elevator car status is exchanged between the at least two of the car controllers 104. The elevator car status can include a safety chain status. Safety chain status can include an indication of an emergency stop, brake deployment, system fault, or other such condition that prevents an elevator car 14 from reaching a commanded destination. Further, the elevator car status can include a target and motion status, such as a position, speed, acceleration, and the like. Other such status information can include an opened/closed status of elevator doors and/or an operating mode (e.g., normal operating mode, service/maintenance operating mode, non-operational mode, etc.).

At block 508, movement of at least two elevator cars 14 in the multicar hoistway 11, 211 is controlled based on the elevator car status and one or more commands received through at least one of the centralized control flows 106. The one or more commands received through at least one of the centralized control flows 106 can be relayed (e.g., repeated) on at least one of the car-to-car control flows 108. The car controller 104 can use a relayed version of the one or more commands received on at least one of the car-to-car control flows 108 based on detecting a fault in one of the centralized control flows 106 directly received from the centralized controller 102. The car controllers 104 can compare a relayed version of the one or more commands received on at least one of the car-to-car control flows 106 to the one or more commands received directly received from the centralized controller 102. For instance, a voting comparison can be used to confirm that the commands match.

Control of at least two of the elevator cars 14 in the multicar hoistway 11, 211 may include delaying one or more of elevator door closure and elevator car departure based on the elevator car status or planning data received through at least one of the car-to-car control flows 108. Controlling movement of at least two of the elevator cars 14 in the multicar hoistway 11, 211 can include delaying completion of a movement command from the centralized controller 102 in response to a movement delay status of a nearest elevator car 14 in a targeted path of movement. Control of at least two of the elevator cars 14 in the multicar hoistway 11, 211 may include adjusting a targeted stopping floor based on the elevator car status or planning data received through at least one of the car-to-car control flows 108. Further, controlling movement of at least two of the elevator cars 14 in the multicar hoistway 11, 211 can include adjusting a travel speed based on the elevator car status of a nearest elevator car in a direction of travel 212.

In some embodiments, a car controller 104 association with an elevator car 14 changes as the elevator car 14 travels in the multicar hoistway 11, 211. For example, car controller 104A may control the elevator car 14A in closest physical proximity, which can change as elevator cars 14 travel through the multicar hoistway 11, 211. With decentralized control, car controller 104B can change a targeted destination or speed of elevator car 14B based on determining that elevator car 14A has not moved as commanded. Rather than waiting for car controller 104A to report a fault to the centralized controller 102 and for the centralized controller 102 to relay a new command to the car controller 104B, the car-to-car control flow 108 from car controller 104A to car controller 104B can improve the reaction time of car controller 104B relative to a condition detected by car controller 104A. Further, the car-to-car control flow 108 can provide an alternate or redundant communication path if one or more of the centralized control flows 106 has a fault condition.

While the above description has described the flow process of FIG. 5 in a particular order, it should be appreciated that unless otherwise specifically required in the attached claims that the ordering of the steps may be varied.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A system comprising:
a centralized controller configured to coordinate movement of a plurality of elevator cars in a multicar hoistway; and
a plurality of car controllers configured to communicate with the centralized controller through a plurality of centralized control flows, establish two or more car-to-car control flows between at least two of the car controllers, and exchange an elevator car status between at least two of the car controllers, wherein movement of at least two of the elevator cars in the multicar hoistway is controlled based on the elevator car status and one or more commands received through at least one of the centralized control flows.

2. The system of claim 1, wherein the one or more commands received through at least one of the centralized control flows are relayed on at least one of the car-to-car control flows.

3. The system of claim 2, wherein the car controllers are configured to use a relayed version of the one or more commands received on at least one of the car-to-car control flows based on detecting a fault in one of the centralized control flows directly received from the centralized controller.

4. The system of claim 2, wherein the car controllers are configured to compare a relayed version of the one or more commands received on at least one of the car-to-car control flows to the one or more commands received directly received from the centralized controller.

5. The system of claim 1, wherein the elevator car status comprises one or more of a safety chain status, a target stopping floor, and a motion status.

6. The system of claim 1, wherein control of at least two of the elevator cars in the multicar hoistway comprises delaying one or more of elevator door closure and elevator car departure based on the elevator car status or planning data received through at least one of the car-to-car control flows.

7. The system of claim 1, wherein control of at least two of the elevator cars in the multicar hoistway comprises delaying completion of a movement command from the centralized controller in response to a movement delay status of a nearest elevator car in a targeted path of movement.

8. The system of claim 1, wherein control of at least two of the elevator cars in the multicar hoistway comprises adjusting a travel speed based on planning data or the elevator car status of one or more elevator cars in a targeted path of movement.

9. The system of claim 1, wherein the two or more car-to-car control flows between at least two of the car controllers comprise at least one car-to-car control flow that extends beyond a nearest car controller in a targeted path of movement.

10. The system of claim 1, wherein control of at least two of the elevator cars in the multicar hoistway comprises adjusting a targeted stopping floor based on the elevator car status or planning data received through at least one of the car-to-car control flows.

11. A method comprising
establishing a plurality of centralized control flows between a centralized controller and a plurality of car controllers of a multicar hoistway;
establishing two or more car-to-car control flows between at least two of the car controllers;
exchanging an elevator car status between the at least two of the car controllers; and
controlling movement of at least two elevator cars in the multicar hoistway based on the elevator car status and one or more commands received through at least one of the centralized control flows.

12. The method of claim 11, further comprising:
relaying the one or more commands received through at least one of the centralized control flows on at least one of the car-to-car control flows.

13. The method of claim 12, further comprising:
using, by the car controllers, a relayed version of the one or more commands received on at least one of the car-to-car control flows based on detecting a fault in one of the centralized control flows directly received from the centralized controller.

14. The method of claim 12, further comprising:
comparing, by the car controllers, a relayed version of the one or more commands received on at least one of the car-to-car control flows to the one or more commands received directly received from the centralized controller.

15. The method of claim 11, wherein the elevator car status comprises one or more of a safety chain status, a target stopping floor, and a motion status.

16. The method of claim 11, wherein controlling movement of at least two of the elevator cars in the multicar hoistway comprises delaying one or more of elevator door closure and elevator car departure based on the elevator car status or planning data received through at least one of the car-to-car control flows.

17. The method of claim 11, wherein controlling movement of at least two of the elevator cars in the multicar hoistway comprises delaying completion of a movement command from the centralized controller in response to a movement delay status of a nearest elevator car in a targeted path of movement.

18. The method of claim 11, wherein controlling movement of at least two of the elevator cars in the multicar hoistway comprises adjusting a travel speed based on planning data or the elevator car status of one or more elevator cars in a targeted path of movement.

19. The method of claim 11, wherein the two or more car-to-car control flows between at least two of the car controllers comprise at least one car-to-car control flow that extends beyond a nearest car controller in a targeted path of movement.

20. The method of claim 11, wherein controlling movement of at least two of the elevator cars in the multicar hoistway comprises adjusting a targeted stopping floor based on the elevator car status or planning data received through at least one of the car-to-car control flows.
